(19) United States
(12) Patent Application Publication
(10) Pub. No.: US 2018/0209124 A1
(43) Pub. Date: Jul. 26, 2018

(54) WATER LEAKAGE DIAGNOSIS DEVICE, WATER LEAKAGE DIAGNOSIS METHOD, AND NON-TRANSITORY COMPUTER READABLE STORAGE MEDIUM

(71) Applicants: Kabushiki Kaisha Toshiba, Minato-ku (JP); Toshiba Infrastructure Systems & Solutions Corporation, Kawasaki-shi (JP)

(72) Inventors: Katsuya Yokokawa, Fuchu (JP); Osamu Yamanaka, Hachioji (JP); Ryo Namba, Kawasaki (JP); Toshiharu Sugino, Fuchu (JP)

(73) Assignees: Kabushiki Kaisha Toshiba, Minato-ku (JP); Toshiba Infrastructure Systems & Solutions Corporation, Kawasaki-shi (JP)

(21) Appl. No.: 15/933,622

(22) Filed: Mar. 23, 2018

Related U.S. Application Data
(63) Continuation of application No. PCT/JP2016/072822, filed on Aug. 3, 2016.

(30) Foreign Application Priority Data
Sep. 25, 2015 (JP) 2015-188396

(51) Int. Cl. E03B 7/07; G01M 3/28; F17D 5/06

(52) U.S. Cl. CPC E03B 7/072; E03B 7/078; G05B 19/0428; F17D 5/06; G01M 3/2815

(57) ABSTRACT

A water leakage diagnosis device in an embodiment includes a total water leakage amount acquirer, a node water usage amount acquirer, a node water leakage amount estimator, an estimation parameter setting unit, and a water leakage location estimator. The total water leakage amount acquirer acquires a total water leakage amount in a pipe line network on the basis of an amount of water flowing into a pipe line network and an amount of water used by a customer in the pipe line network. The node water usage amount acquirer acquires a node water usage amount indicating a total amount of an amount of water to be used at each node in the pipe line network. The node water leakage amount estimator estimates the node water leakage amount a plurality of times on the basis of the total water leakage amount, the node water usage amount, and an estimation parameter. The water leakage location estimator estimates a water leakage location in the pipe line network on the basis of a plurality of estimated results of the node water leakage amount. The node water leakage amount estimator estimates the node water leakage amount using different estimation parameters for each of estimations of the node water leakage amount performed a plurality of times.

### CROSS REFERENCE TO RELATED APPLICATION

This is a Continuation Application of International Application No. PCT/JP2016/072822, filed on Aug. 3, 2016, which claims priority to Japanese Patent Application No. 2015-188396, filed on Sep. 25, 2015, and the entire contents of all of the aforementioned applications are incorporated herein by reference.

### FIELD

Embodiments described herein relate generally to a water leakage diagnosis device, a water leakage diagnosis method, and a non-transitory computer readable storage medium.

### BACKGROUND

Generally, the investigation of water leakage in a water supply pipe line network includes a primary investigation for investigating the presence of water leakage and a secondary investigation for identifying a water leakage location. The primary investigation is an investigation conducted regularly by an investigator in which the investigator investigates the presence of water leakage in a water supply pipe line network using a sound listening rod or the like. The secondary investigation is an investigation conducted on a region in which it is determined that water is highly likely to be leaking as a result of the primary investigation and a water leakage location is identified using a correlation type water leakage detection device or the like. However, the primary investigation is generally evenly conducted on regions to be investigated and a specific region to be mainly investigated is not considered in the current situation.

On the other hand, the introduction of a water supply smart meter is considered against a backdrop of increasing awareness of environmental issues. A water supply smart meter is a device that enables a user to measure an amount of water used by each customer at any time and in detail. It is thought that efficient water supply will become possible in consideration of tendency, a pattern, or the like of a need of water through installation of such a water supply smart meter. In addition, when a needed amount of water acquired by a water supply smart meter and a water pressure in a water supply pipe line network acquired by a water pressure gauge are used, it is thought that water leakage diagnosis of a water supply pipe line network will be easier to carry out.

When water leakage diagnosis is performed by such a method, accuracy of diagnosis depends on the number of water pressure gauges installed in a water supply pipe line network. However, there may be a case in which a water pressure gauge in which a sufficiently accurate diagnosis result can be obtained is not necessarily installed in the water supply pipe line network.

### BRIEF DESCRIPTION OF THE DRAWINGS

FIG. 1 is a diagram illustrating a specific example of a water distribution facility according to an embodiment.

FIG. 2 is a functional block diagram showing a functional constitution of a water leakage diagnosis device 1 in an embodiment.

FIG. 3 is a flowchart for describing a flow of a water leakage diagnosis process through the water leakage diagnosis device 1 in the embodiment.

FIG. 4 is a diagram illustrating a specific example of an estimation result of a node water leakage amount.

FIG. 5 is a diagram illustrating a specific example of a diagnosis result screen.

### DETAILED DESCRIPTION

A water leakage diagnosis device, a water leakage diagnosis method, and a non-transitory computer readable storage medium according to an embodiment will be described below with reference to the drawings.

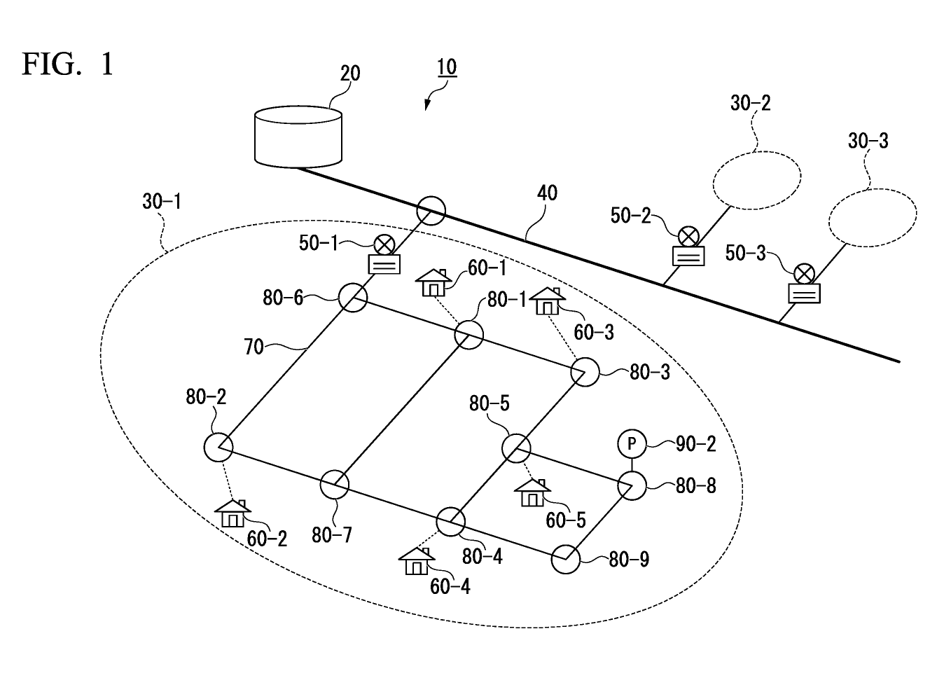

FIG. 1 is a diagram illustrating a specific example of a water distribution facility according to an embodiment. A water distribution facility 10 in FIG. 1 supplies water stored in a water distribution reservoir 20 to water distribution blocks 30-1 to 30-3. The water distribution blocks 30-1 to 30-3 indicate areas included in a region serving as a water distribution target (hereinafter referred to as a “water distribution target region”). A main line 40 is a pipe line serving as a line through which water stored in the water distribution reservoir 20 is fed to each of the water distribution blocks 30-1 to 30-3. Flowmeters 50-1 to 50-3 configured to measure an inflow rate to the water distribution blocks are installed in inflow sections from the main line 40 to the water distribution blocks 30-1 to 30-3.

Pipe line networks for supplying water to customers in the areas are laid in the water distribution blocks 30-1 to 30-3. For example, customers 60-1 to 60-5 are in the water distribution block 30-1 and a pipe line network 70 is laid. Water supplied to the customers 60-1 to 60-5 in the water distribution block 30-1 is drawn from any of nodes 80-1 to 80-9 in pipe lines constituting the pipe line network 70. For example, water supplied to the customer 60-1 is drawn from the node 80-1. Similarly, water supplied to the customers 60-2 to 60-5 is drawn from the nodes 80-2 to 80-5. Amounts of water used by the customers 60-1 to 60-5 are measured by water supply smart meters (hereinafter referred to as “smart meters”) installed for the customers 60-1 to 60-5. For example, an amount of water used by each customer is measured in units of one liter every hour.

Also, water pressure gauges configured to measure a water pressure are installed at some nodes in a pipe line network laid in a water distribution block. For example, in the water distribution block 30-1, water pressure gauges 90-1 and 90-2 are installed in the nodes 80-4 and 80-8.

The water leakage diagnosis device in the embodiment estimates a water leakage amount at each node (hereinafter referred to as a “node water leakage amount”) on the basis of water pressures acquired from some nodes among nodes constituting the pipe line network laid in the water distribution block for each water distribution block in the water distribution facility like in the above example.

A constitution of the water leakage diagnosis device in the embodiment will be described below using a case in which the water distribution block 30-1 in FIG. 1 is a diagnosis object as an example. Note that, for the sake of simplicity of explanation, hereinafter, the water distribution block 30-1 is referred to as a water distribution block 30. Similarly, the flowmeter 50-1 is referred to as a flowmeter 50.

Also, for the same reason, the customers 60-1 to 60-5 in the water distribution block 30 are referred to as a customer 60 as far as there is no need to particularly distinguish them. Similarly, the nodes 80-1 to 80-9 are referred to as a node 80. Similarly, the water pressure gauges 90-1 and 90-2 are referred to as a water pressure gauge 90.

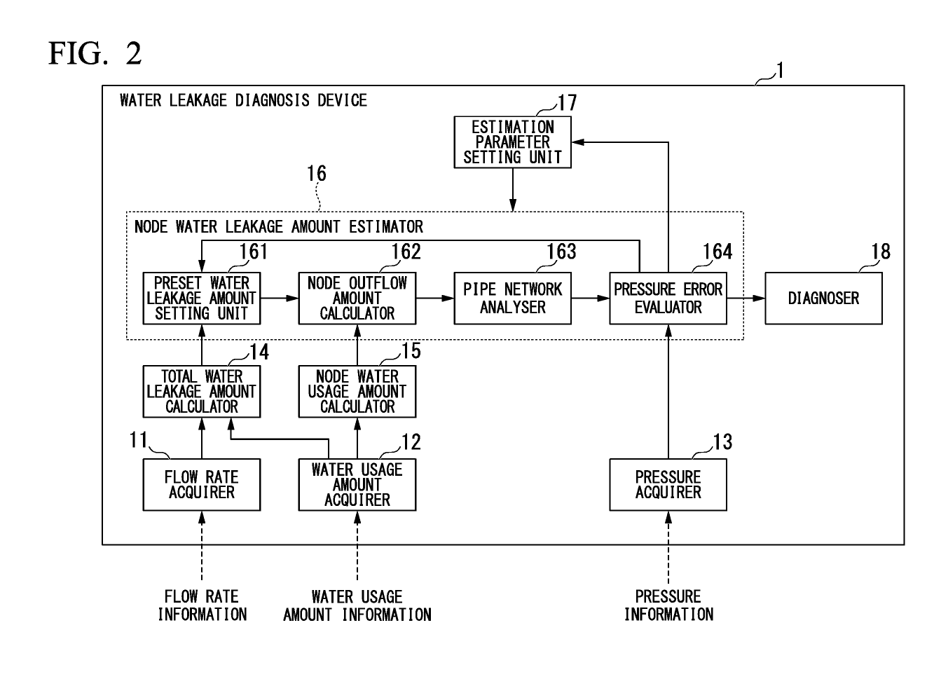

FIG. 2 is a functional block diagram showing a functional constitution of a water leakage diagnosis device 1 in the embodiment. The water leakage diagnosis device 1 includes a central processing unit (CPU), a memory, an auxiliary storage device, a communication interface, and the like connected through buses and executes a water leakage diagnosis program. The water leakage diagnosis device 1 functions as a device including a flow rate acquirer 11, a water usage amount acquirer 12, a pressure acquirer 13, a total water leakage amount calculator 14, a node water usage amount calculator 15, a node water leakage amount estimator 16, an estimation parameter setting unit 17, and a diagnoser 18 by executing the water leakage diagnosis program. Note that all or some functions of the water leakage diagnosis device 1 may be realized using hardware such as an application specific integrated circuit (ASIC), a programmable logic device (PLD), a field programmable gate array (FPGA), or the like. The water leakage diagnosis program may be recorded on a computer-readable recording medium. The computer-readable recording medium is, for example, a portable medium such as a flexible disk, a magneto-optical disc, a read only memory (ROM), and a compact disc read only memory (CD-ROM) or a storage device such as a hard disk built in a computer system. The water leakage diagnosis program may be transmitted via a telecommunication line.

The flow rate acquirer 11 acquires flow rate information indicating an amount of water flowing from the main line 40 into the pipe line network 70. The flow rate information is generated in the flowmeter 50. The flow rate acquirer 11 may acquire the flow rate information by communicating with the flowmeter 50 and acquire the flow rate information by accessing a storage medium storing the flow rate information.

The water usage amount acquirer 12 acquires water usage amount information indicating an amount of water used by the customer 60 in the water distribution block 30. The water usage amount information is generated by a smart meter installed for each customer 60. The water usage amount acquirer 12 may acquire the water usage amount information by communicating with the smart meter and acquire the water usage amount information by accessing a storage medium storing the water usage amount information.

The pressure acquirer 13 acquires pressure information indicating water pressures at several nodes of the pipe line network 70. The pressure information is generated by water pressure gauges installed at the several nodes of the pipe line network 70. For example, in the water distribution facility 10 in FIG. 1, pressure information is generated by the water pressure gauge 90-1 installed at the node 80-4 and the water pressure gauge 90-2 installed at the node 80-8. The pressure acquirer 13 may acquire the pressure information by communicating with the water pressure gauge 90 and acquire the pressure information by accessing a storage medium storing the pressure information.

The total water leakage amount calculator 14 (total water leakage amount acquirer) calculates a total amount of leakage in the entire pipe line network 70 (hereinafter referred to as a “total water leakage amount”). For example, the total water leakage amount calculator 14 calculates a total water leakage amount by subtracting a total amount of water used by the customers 60 indicated by water usage amount information from an inflow rate into the pipe line network 70 indicated by the flow rate information.

The node water usage amount calculator 15 (node water usage amount acquirer) calculates a total amount of water used by the customers 60 at nodes in the pipe line network 70 (hereinafter referred to as a “node water usage amount”). To be specific, the node water usage amount calculator 15 calculates the node water usage amount by summing amounts of water used by the customers 60 indicated by water usage amount information for each node in the pipe line network 70.

The node water leakage amount estimator 16 estimates a node water leakage amount on the basis of actually measured values of water pressure measured at several nodes indicated by total water leakage amounts, node water usage amounts, and pressure information. To be specific, the node water leakage amount estimator 16 includes a preset water leakage amount setting unit 161, a node outflow amount calculator 162, a pipe network analysis unit 163, and a pressure error evaluation unit 164.

The preset water leakage amount setting unit 161 sets a provisional water leakage amount (hereinafter referred to as a “preset water leakage amount”) for each node in the pipe line network. The preset water leakage amount setting unit 161 sets a preset water leakage amount so that a sum of preset water leakage amounts at nodes is a total water leakage amount.

The node outflow amount calculator 162 calculates an amount of water flowing out from each node (hereinafter referred to as a “node outflow amount”) by water leakage or use of the customer 60. To be specific, the node outflow amount calculator 162 calculates a sum of a preset water leakage amount at each node set by the preset water leakage amount setting unit 161 and a node water usage amount at each node calculated by the node water usage amount calculator 15 as a node outflow amount at each node.

The pipe network analysis unit 163 calculates pressure (effective water pressure) at each node on the basis of a pipe network analysis model representing a relationship between a flow rate and a water pressure in the pipe line network. According to the pipe network analysis model, pressure at each node can be calculated, for example, according to the following expression (1).

### [Math. 1]

ΔPᵢⱼ=Pᵢ−Pⱼ=10.666LᵢⱼC_{H}^{-1.85}Dᵢⱼ^{-4.87}qᵢⱼ^{1.85} Expression (1)

In Expression (1), i and j are identification numbers of nodes constituting the pipe line network 70. In the following description, a node identified by i is referred to as a node i and a node identified by j is referred to as a node j. Furthermore, a pipe line having a node i as a start point and a node j as an end point is referred to as a pipe line ij. ΔPᵢⱼ represents a pressure difference between the node i and the node j. In other words, ΔPᵢⱼ represents a pressure loss [m] in the pipe line ij. Pᵢ represents a water pressure [m] at a node i that is a start point of the pipe line ij and Pⱼ represents a water pressure [m] at a node j that is an end point thereof. Lᵢⱼ represents an extension [m] of the pipe line ij. C_{H} represents a coefficient of friction of the pipe line. The coefficient of friction C_{H} is uniquely determined in accordance with a material of the pipe line. Dᵢⱼ represents a bore [m] of the pipe line. qᵢⱼ represents a node outflow amount [m³/h] per unit time flowing through the pipe line ij.

Accuracy of pressure at each node (hereinafter referred to as a “node pressure”) calculated through pipe network analysis is largely affected by accuracy of a node outflow amount qᵢⱼ. For this reason, in order to analyze the pipe network with high accuracy, a more accurate amount of water used at each node is required. In the water distribution block in which the smart meter is installed for each customer, an accurate amount of water used at each node can be acquired by summing amounts of water to be used measured by the smart meters of the customers for each corresponding node.

The pressure error evaluation unit 164 evaluates an error between an estimated value of a node pressure calculated by the pipe network analysis unit 163 and an actually measured value (hereinafter referred to as a “pressure error”). Through the evaluation of the pressure error, the pressure error evaluation unit 164 determines a preset water leakage amount at which an error of the node pressure is minimized as an estimated value of a node water leakage amount. Estimation of the node water leakage amount is formulated as an optimization problem, for example, as illustrated in the following expressions (2) to (4).

### [Math. 2]

min. α₁ƒ₁+α₂ƒ₂ Expression (2)

### [Math. 3]

ƒ₁=Σₜ₌₁^{T}Σₖ^{M}{Pₘₖ(t)−Pₖ(t)}² Expression (3)

### [Math. 4]

ƒ₂=Σₜ₌₁^{T}{Q_{L}(t)−Σᵢ₌₁^{N} Q_{Li}(t)}² Expression (4)

### [Math. 5]

s.t. Pᵢ(t)≥0 Expression (5)

Expression (2) represents an evaluation function serving as an index of optimization. f₁ is a function expressing a square error between an actually measured value and an estimated value of a node pressure. f₂ is a function expressing a square error between an actually measured value and an estimated value of a total water leakage amount. α₁ is a weighting coefficient for f₁ of the evaluation function and α₂ is a weighting coefficient for f₂ thereof. Expression (2) represents an optimization problem of acquiring a minimum value of the evaluation function.

In Expression (3), k represents an identification number of a node from which an actually measured value of a node pressure is obtained. M represents a maximum value of k. If a node pressure is measured at a node with a node number of 1, 10, M=2. Pₘₖ(t) represents an actually measured value of a node pressure at time t at a node identified by k (hereinafter referred to as a “node k”). Pₖ(t) represents an estimated value of a node pressure at time t at the node k. T represents a maximum value of t.

In Expression (4), QL(t) represents a total water leakage amount at time t. N represents a maximum value of i. Q_{Li}(t) represents an estimated value of a node water leakage amount at time t at a node i identified by an identification number i of a node. Expression (5) is a conditional expression expressing a constraint that a value that can be taken by an estimated value Pᵢ(t) of a node pressure is zero or more. The pressure error evaluation unit 164 obtains a minimum value of the evaluation function by solving the above optimization problem.

The node water leakage amount estimator 16 repeatedly performs estimation of the node pressure by the pipe network analysis unit 163 and evaluation of the pressure error by the pressure error evaluation unit 164 while changing setting of a preset water leakage amount to determine a preset water leakage amount when the evaluation function takes a minimum value as an estimated value of a node water leakage amount. The node water leakage amount estimator 16 outputs a node water leakage amount estimated in this way to the diagnoser 18. Furthermore, the node water leakage amount estimator 16 performs the process of estimating the node water leakage amount a plurality of times while changing an estimation parameter. The estimation parameter is a parameter such as a boundary condition or an initial condition used for estimating a node water leakage amount. The estimation parameter is set by the estimation parameter setting unit 17.

As described above, estimation accuracy of a node water leakage amount through optimization of a pressure error depends on the number of nodes at which a node pressure is actually measured, that is, the number of water pressure gauges 90. This is because setting parameters of a plurality of preset water leakage amounts for a minimum value of the same pressure error are highly likely to be obtained when the number of water pressure gauges 90 is not sufficient. Furthermore, in such an optimization method, there is a problem that, when the evaluation function has multimodality, only one among a plurality of optimum solutions (here, minimum values) can be obtained. In other words, this means that only one among a plurality of water leak portions is able to be likely to be identified despite the existence of the water leak portions. An optimum solution to be obtained is determined depending on an estimation parameter of an estimation process. Examples of the estimation parameter include parameters such as an initial value of the estimation process or a weighting coefficient of the evaluation function, the number of loops of the estimation process, and the amount of data or the number of nodes used in the estimation process. For this reason, the water leakage diagnosis device 1 in the embodiment performs estimation of a node water leakage amount a plurality of times using various estimation parameters to improve estimation accuracy of the node water leakage amount. The estimation parameter setting unit 17 sets different estimation parameters for the estimation process of the node water leakage amount the plurality of times performed by the node water leakage amount estimator 16.

The diagnoser 18 (water leakage location estimator) acquires a plurality of estimated results of the node water leakage amount estimated under estimation parameters with various patterns set by the estimation parameter setting unit 17 and diagnoses a possibility of water leakage on the basis of the plurality of estimation results.

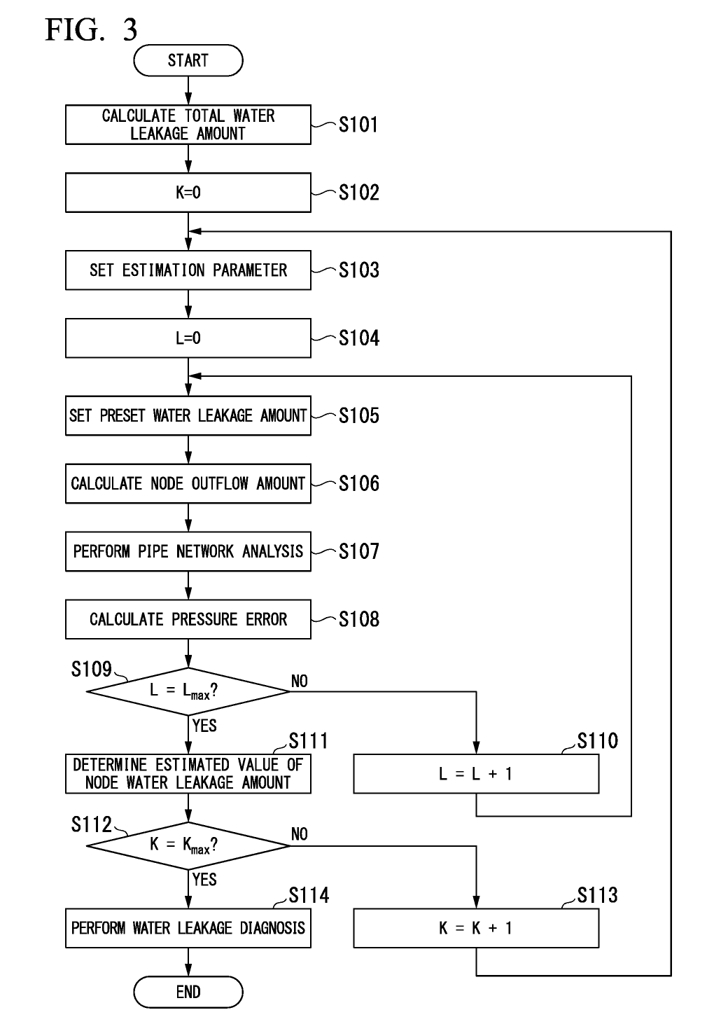

FIG. 3 is a flowchart for describing a flow of a water leakage diagnosis process through the water leakage diagnosis device 1 in the embodiment. First, the total water leakage amount calculator 14 calculates a total water leakage amount over the entire water distribution block on the basis of the flow rate information and the water usage amount information (Step S101). The total water leakage amount calculator 14 outputs the calculated value of the total water leakage amount to the node water leakage amount estimator 16.

Subsequently, the estimation parameter setting unit 17 initializes an estimation number K of the node water leakage amount by the node water leakage amount estimator 16 to zero (Step S102). The estimation parameter setting unit 17 sets an estimation parameter of the node water leakage amount for the node water leakage amount estimator 16 when initializing the estimation number K to zero (Step S103). The node water leakage amount estimator 16 performs the estimation process of the node water leakage amount on the basis of the total water leakage amount, the node water usage amount, the actually measured value of the node pressure, and the estimation parameter set by the estimation parameter setting unit 17.

To be specific, the preset water leakage amount setting unit 161 initializes the number of times of setting the preset water leakage amount to zero (Step S104). The preset water leakage amount setting unit 161 sets the preset water leakage amount at each node in the pipe line network when initializing the number of times of setting to zero (Step S105). When it is ascertained that water leakage is less likely to occur for a specific node in advance, the preset water leakage amount setting unit 161 may set, for the node, a preset water leakage amount sufficiently smaller than the other nodes. Estimation accuracy of the node water leakage amount can be improved by setting such a preset water leakage amount.

The node outflow amount calculator 162 calculates the node outflow amount on the basis of a preset water leakage amount at each node and a node water usage amount at each node (Step S106). The pipe network analysis unit 163 performs a pipe network analysis on the basis of the node outflow amount at each node (Step S107). By performing the pipe network analysis, the pipe network analysis unit 163 calculates an estimated value of a node pressure at each node.

The pressure error evaluation unit 164 calculates a pressure error between the estimated value of the node pressure calculated by the pipe network analysis unit 163 and an actually measured value of the node pressure (Step S108). To be specific, the pipe network analysis unit 163 calculates a square error of the estimated value of the node pressure and the actually measured value of node pressure as a pressure error.

Subsequently, the pressure error evaluation unit 164 determines whether a set number L of the preset water leakage amount is equal to a preset maximum value Lₘₐₓ (Step S109). If it is determined that the set number L is not equal to the maximum value Lₘₐₓ (NO in Step S109), the pressure error evaluation unit 164 increments the set number L (Step S110) and the process returns to the process of Step S105. When a subsequent L+1^{th} preset water leakage amount is set, the preset water leakage amount setting unit 161 sets a preset water leakage amount with a distribution different from that at the previous L^{th} time. In other words, the estimation process of the node pressure is repeatedly performed on the basis of the preset water leakage amount set with a different distribution until the set number L becomes equal to the maximum value Lₘₐₓ. On the other hand, if it is determined that the set number L is equal to the maximum value Lₘₐₓ (YES in Step S109), the pressure error evaluation unit 164 determines a preset water leakage amount in an estimated result in which a pressure error is a minimum value among previous L estimated results as an estimated value of the node water leakage amount (Step S111).

The pressure error evaluation unit 164 does not necessarily need to determine a node water leakage amount at a certain estimation parameter on the basis of an estimated result at the Lₘₐₓ^{th} time. For example, when a pressure error equal to or less than a preset threshold value is obtained, the pressure error evaluation unit 164 may determine a preset water leakage amount at that time as an estimated value of the node water leakage amount. In this case, the node water leakage amount estimator 16 may skip the estimation process after that time and proceed to a subsequent estimation process with the estimation parameter.

Subsequently, the pressure error evaluation unit 164 determines whether the estimation number K of the node water leakage amount is equal to a preset maximum value Kₘₐₓ (Step S112). If it is determined that the estimation number K is not equal to the maximum value Kₘₐₓ (NO in Step S112), the pressure error evaluation unit 164 increments the estimation number K (Step 5113) and the process returns to the process of Step 5103. When a subsequent K+1^{th} estimation parameter is set, the estimation parameter setting unit 17 sets an estimation parameter for which some or all parameter values are different from those at the previous K^{th} time. In other words, the estimation process of the node water leakage amount is repeatedly performed on the basis of different estimation parameters until the estimation number K is equal to the maximum value Kₘₐₓ.

Also, the estimation parameter setting unit 17 sets an estimation parameter at each time so that values of estimation parameters set a plurality of times have a sufficient variation within a range of possible values. For example, the estimation parameter setting unit 17 sets a plurality of estimation parameters so that statistical values indicating degrees of variation of values of a plurality of estimation parameters (for example, statistical values such as variance or standard deviation) represent variations with sizes equal to or larger than a predetermined value. As described above, the estimation parameter having the sufficient variation is set at each time so that reliability of water leakage diagnosis based on a plurality of estimated results can be improved.

On the other hand, if it is determined that the set number K is equal to the maximum value Kₘₐₓ (YES in Step S112), the diagnoser 18 performs the water leakage diagnosis for the pipe line network on the basis of the node water leakage amount estimated by the pressure error evaluation unit 164 (Step S114). To be specific, the diagnoser 18 diagnoses a possibility of water leakage at each node on the basis of estimated results of node water leakage amounts acquired by the number of times an estimation parameter is set by the estimation parameter setting unit 17.

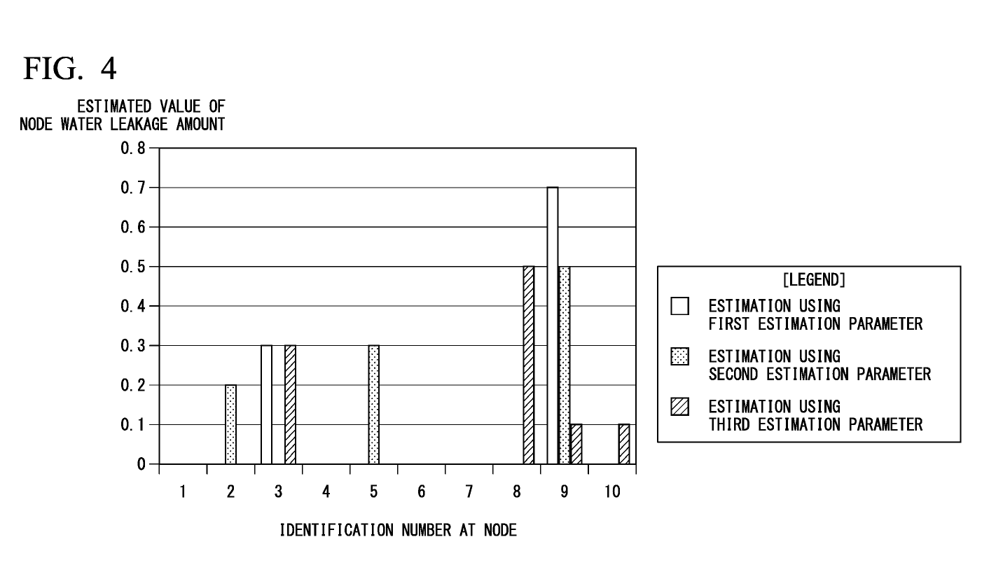

FIG. 4 is a diagram illustrating a specific example of an estimation result of a node water leakage amount. In FIG. 4, a horizontal axis represents an identification number at each node in a pipe line network and a vertical axis represents an estimated value of a node water leakage amount at each node. In the example in FIG. 4, estimated values of the node water leakage amount estimated for each of first to third types of estimation parameters are illustrated. A possibility of water leakage at each node based on such estimated results may be determined on the basis of any determination criteria or way of thinking.

For example, in the case of the example of FIG. 4, the diagnoser 18 may determine that a node 9 at which water leakage is estimated by all of the estimated results for various estimation parameters is a water leakage location. Furthermore, the diagnoser 18 may determine, as water leakage locations, a node 3 and the node 9 at which water leakage is estimated by two or more types of estimated results among three types of estimated results. The diagnoser 18 may determine, as water leakage locations, a node 2, the node 3, a node 5, a node 8, the node 9, and a node 10 at which water leakage is estimated by one or more types of estimated results among three types of estimated results.

Also, the diagnoser 18 may not only determine a water leakage location, but also indicate a possibility of water leakage at each node by a numerical value. For example, the diagnoser 18 may sum the node water leakage amount obtained from various kinds of estimated results for each node and indicate a possibility of water leakage at each node by a relative magnitude of a summed value. The diagnoser 18 may display a diagnosis result screen indicating the above determination result or possibility of water leakage.

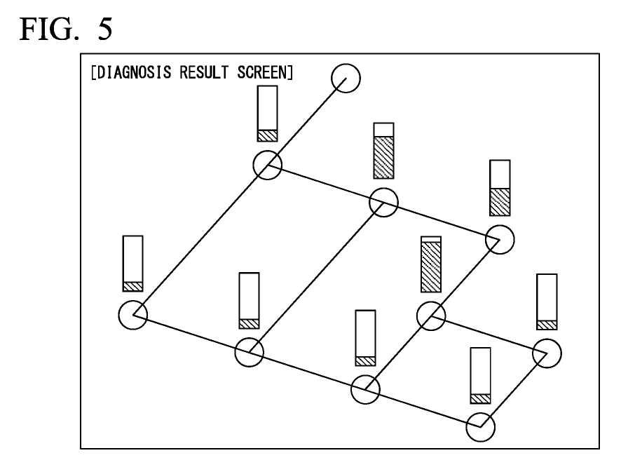

FIG. 5 is a diagram illustrating a specific example of a diagnosis result screen. A diagnosis result screen in the example of FIG. 5 is an example in which a possibility of water leakage at each node in a pipe line network is displayed by a gauge attached to each node. Such a diagnosis result screen is displayed so that an administrator of the pipe line network can easily visually determine a pipe line to be preferentially inspected.

The water leakage diagnosis device 1 of the embodiment configured as described above estimates a preset water leakage amount at which an error between an estimated value of a node pressure and an actually measured value is minimum as a node water leakage amount and determines a water leakage location in the pipe line network on the basis of node water leakage amounts estimated by a plurality of estimation parameters. With such a constitution, the water leakage diagnosis device 1 can perform water leakage diagnosis with high accuracy even if a sufficient number of water pressure gauges are not installed in the pipe line network.

A modified example of the water leakage diagnosis device 1 in the embodiment will be described below.

As described above, accuracy of the node pressure calculated through the pipe network analysis is largely affected by accuracy of the node outflow amount qᵢⱼ. For this reason, in order to analyze the pipe network analysis with high accuracy, a more accurate node water usage amount is required. However, in a water distribution block in which smart meters are not sufficiently distributed, an amount of water used by each of the customers is likely to be unable to be ascertained with high accuracy. For this reason, in a water distribution block in which smart meters are not distributed, read data of a water faucet meter connected to each node may be used when a node water usage amount is calculated. The read data is information indicating an amount of water supplied through each faucet.

Here, generally, the read data is acquired as a cumulative value for a certain long period. For example, the read data is acquired by bi-monthly reading. For this reason, when an amount of water to be supplied handled as a cumulative value for a such a certain long period (hereinafter referred to as a “period water supply amount) is used for pipe network analysis, it is necessary to convert the period water supply amount into an amount of water to be supplied (hereinafter referred to as a “unit water supply amount”) per unit time (for example, one hour) in the pipe network analysis. For example, the unit water supply amount can be obtained by dividing a daily average water supply amount calculated from the period water supply amount for each unit time in accordance with a daily demand pattern.

Generally, an amount of water to be used at night is considered to be small. For this reason, according to a size of a water distribution block, an inflow rate to the water distribution block at night is a total water leakage amount in some cases. In such a case, the water leakage diagnosis device 1 may be configured to acquire a total water leakage amount on the basis of flow rate information. With such a constitution, a total water leakage amount can be acquired without using read data in a water distribution block in which smart meters are not distributed.

Each node may be set to reflect regional characteristics of a water distribution block. For example, more preset water leakage amounts may be assigned to nodes located in an urban area with a large population and fewer preset water leakage amounts may be assigned to nodes located in a suburban area with a small population. Furthermore, for example, when it is ascertained in advance that there is a large amount of water leakage in a predetermined area (for example, a downtown area), setting may be performed so that more preset water leakage amounts are assigned to nodes located in the predetermined area. Such regional characteristics are reflected so that it is possible to estimate a more accurate water leakage location.

When a total water leakage amount or an amount of increase of the total water leakage amount calculated on the basis of the flow rate information or the water usage amount information exceeds a predetermined threshold value, the water leakage diagnosis device 1 may include a notification unit configured to notify a user of the device to prompt determination concerning whether to perform the estimation process of the node water leakage amount. In this case, the water leakage diagnosis device 1 includes an input unit configured to receive an input of a user's operation and may be configured to perform estimation of the node water leakage amount and water leakage diagnosis in response to the user's instruction that is input in response to the notification.

The flow rate acquirer 11 may be configured to acquire total water leakage amount information indicating the total water leakage amount instead of the flow rate information. In this case, the water leakage diagnosis device 1 may be configured as a device which does not include the total water leakage amount calculator 14. Similarly, the water usage amount acquirer 12 may be configured to acquire node water usage amount information indicating a node water usage amount instead of the water usage amount information. In this case, the water leakage diagnosis device 1 may be configured as a device which does not include the node water usage amount calculator 15.

According to at least one embodiment described above, a node water leakage amount estimator configured to estimate a node water leakage amount at each node on the basis of a total water leakage amount in a pipe line network and a node water usage amount at each node in the pipe line network, an estimation parameter setting unit configured to set an estimation parameter used for estimating a node water leakage amount, and a diagnoser are provided, the estimation parameter setting unit sets a different estimation parameter for an estimation process of node water leakage amounts a plurality of times, the node water leakage amount estimator estimates a node water leakage amount for each different estimation parameter, and the diagnoser estimates a water leakage location in the pipe line network on the basis of a plurality of estimated results in the node water leakage amount so that water leakage diagnosis can be performed with high accuracy even if a sufficient number of water pressure gauges are not installed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A water leakage diagnosis device comprising:
a total water leakage amount acquirer configured to acquire a total water leakage amount in a pipe line network on the basis of an amount of water flowing into the pipe line network that is a water supply target and an amount of water used by a customer in the pipe line network;
a node water usage amount acquirer configured to acquire a node water usage amount indicating a total amount of an amount of water to be used at each node in the pipe line network;
a node water leakage amount estimator configured to estimate the node water leakage amount a plurality of times on the basis of the total water leakage amount acquired by the total water leakage amount acquirer, the node water usage amount acquired by the node water usage amount acquirer, and an estimation parameter required to estimate the node water leakage amount that is a water leakage amount at each node in the pipe line network; and
a water leakage location estimator configured to estimate a water leakage location in the pipe line network on the basis of estimated results of the node water leakage amount estimated a plurality of times by the node water leakage amount estimator,
wherein the node water leakage amount estimator estimates the node water leakage amount using different estimation parameters for each of estimations of the node water leakage amount performed a plurality of times.

2. The water leakage diagnosis device according to claim 1, wherein the node water leakage amount estimator includes:
a preset water leakage amount setting unit configured to set a water leakage amount as a preset water leakage amount by distributing the total water leakage amount acquired by the total water leakage amount acquirer to each node in the pipe line network;
a node outflow amount calculator configured to calculate a node outflow amount indicating an amount of water flowing out of each node on the basis of the preset water leakage amount at each node set by the preset water leakage amount setting unit and the node water usage amount at each node acquired by the node water usage amount acquirer; and
a pipe network analysis unit configured to estimate a node pressure that is a pressure at each node in the pipe line network by performing a pipe network analysis on the basis of the node outflow amount,
wherein the preset water leakage amount setting unit sets different preset water leakage amounts for the estimation process performed a plurality of times by the pipe network analysis unit, and
the node water leakage amount estimator further includes a pressure error evaluation unit configured to determine, as an estimated value of a water leakage amount at each node, a preset water leakage amount in which a minimum difference among differences between a plurality of estimated results of the node pressure and actually measured values of the node pressure acquired at some nodes in the pipe line network is obtained on the basis of the plurality of estimated results of the node pressure.

3. The water leakage diagnosis device according to claim 1, wherein a plurality of estimation parameters used for the estimation process performed the plurality of times by the node water leakage amount estimator are determined so that a statistical value indicating a degree of variation between values of the plurality of estimation parameters indicates a variation with a predetermined magnitude or more.

4. The water leakage diagnosis device according to claim 2, wherein the preset water leakage amount setting unit sets a preset water leakage amount weighted in accordance with regional characteristics corresponding to each node with respect to each node in the pipe line network.

5. The water leakage diagnosis device according to claim 1, wherein the total water leakage amount acquirer acquires an amount of water flowing into the pipe line network at night as the total water leakage amount on the assumption that an amount of water used by the customer at night is zero.

6. The water leakage diagnosis device according to claim 1, further comprising:
a notification unit configured to notify the user of the device of whether to perform the estimation process of the node water leakage amount when the total water leakage amount or an amount of increase of the total water leakage amount exceeds a predetermined threshold value.

7. The water leakage diagnosis device according to claim 2, wherein the preset water leakage amount setting unit sets a preset water leakage amount sufficiently smaller than those of the other nodes for a node for which it is ascertained in advance that water is less likely to leak.

8. A water leakage diagnosis method comprising:
acquiring a total water leakage amount in a pipe line network on the basis of an amount of water flowing into the pipe line network that is a water supply target and an amount of water used by a customer in the pipe line network;
acquiring a node water usage amount indicating a total amount of an amount of water to be used at each node in the pipe line network;
estimating the node water leakage amount a plurality of times on the basis of the total water leakage amount acquired, the node water usage amount acquired, and an estimation parameter required to estimate the node water leakage amount that is a water leakage amount at each node in the pipe line network;
estimating a water leakage location in the pipe line network on the basis of estimated results of the node water leakage amount estimated a plurality of times; and
estimating the node water leakage amount using different estimation parameters for each of estimations of the node water leakage amount performed a plurality of times included.

9. A non-transitory computer readable storage medium that stores a computer program to be excuted by the computer to perform:
acquiring a total water leakage amount in a pipe line network on the basis of an amount of water flowing into the pipe line network that is a water supply target and an amount of water used by a customer in the pipe line network;
acquiring a node water usage amount indicating a total amount of an amount of water to be used at each node in the pipe line network;
estimating the node water leakage amount a plurality of times on the basis of the total water leakage amount acquired, the node water usage amount acquired, and an estimation parameter required to estimate the node water leakage amount that is a water leakage amount at each node in the pipe line network;
estimating a water leakage location in the pipe line network on the basis of estimated results of the node water leakage amount estimated a plurality of times; and
estimating the node water leakage amount using different estimation parameters for each of estimations of the node water leakage amount performed a plurality of times included.
